(19) United States
(12) Patent Application Publication
(10) Pub. No.: US 2008/0105147 A1
(43) Pub. Date: May 8, 2008

(54) Printing Press

(76) Inventors: Torao Iwamoto, Hiroshima (JP); Hiroshi Kobara, Hiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 11/792,394

(22) PCT Filed: Dec. 7, 2005
(86) PCT No.: PCT/JP05/22444

§ 371 Date: Aug. 30, 2007

(30) Foreign Application Priority Data
Dec. 10, 2004 (JP) 2004-359060

(51) Int. Cl. B41F 5/00

(52) U.S. Cl. 101/216

(57) ABSTRACT

An object is to provide a printing press that has a printing plate with a changeable diameter and that can sufficiently prevent oil and oil mist from entering a printing unit. A rotary press (1) having a blanket cylinder (17) with a changeable diameter is provided. The rotary press (1) includes a driven-side frame (23) provided on the circumference of a hole (49) formed in the driven-side frame (23), the driven-side frame (23) extending in a direction substantially orthogonal to the axial direction of a printing cylinder and protruding toward a shaft (33) of the printing cylinder, the shaft (33) passing through the hole (49) formed in the driven-side frame (23); and a first blanket-side labyrinth plate (83) provided around the shaft (33), the first blanket-side labyrinth plate (83) being provided substantially parallel to a first frame-side labyrinth plate (67) in the axial direction, with a gap formed between the first frame-side labyrinth plate (67) and the first blanket-side labyrinth plate (83), wherein an end position of the first frame-side labyrinth plate (67) and an end position of the first blanket-side labyrinth plate (83) are set so that the first frame-side labyrinth plate (67) and the first blanket-side labyrinth plate (83) overlap when the blanket cylinder (17) moves to any position in response to a change in the diameter.

### TECHNICAL FIELD

The present invention relates to a printing press having a printing cylinder whose diameter is changeable.

### BACKGROUND ART

In printing presses, measures are taken to prevent lubricating oil for bearings that support cylinders, such as printing cylinders (i.e., plate cylinder and blanket cylinder), and driving gears, as well as mist produced by this oil, from entering the printing unit and attaching to printed materials and other units.

In a known printing press, since the printing cylinder is attached, at predetermined positions, at side frames, the bearings supporting the printing cylinder can be disposed substantially in contact with the side frames. Therefore, sufficiently effective measures have been taken against oil and oil mist by interposing O-rings between the bearings and the side frames and providing a plurality of labyrinth grooves.

Recently, as described in Patent Documents 1 and 2, printing presses having a printing cylinder whose diameter is changeable have been proposed.

Patent Document 1: Japanese Unexamined Patent Application, Publication No. Hei 05-77391 (paragraphs 0008 to 0015 and FIG. 1)

Patent Document 2: Japanese Unexamined Patent Application, Publication No. Hei 06-171059 (paragraphs 0009 to 0013 and FIGS. 1 and 2)

### DISCLOSURE OF INVENTION

With printing presses that include cylinders whose diameters are changeable, such as those described in Patent Documents 1 and 2, the positions of the central axes move as the diameters of the printing cylinders are changed. In other words, since the axis of the printing cylinder moves, the side frames must be provided with sufficient spaces for allowing the movement of the axis. As a result, the distance between the bearing supporting the printing cylinder and the side frame becomes great, which causes a problem in that known effective sealing methods, such as O-rings, cannot be employed.

The present invention has been conceived in light of the problems described above. Accordingly, it is an object of the present invention to provide a printing press that has a printing cylinder whose diameter is changeable and that is capable of sufficiently preventing oil and oil mist from entering the printing unit.

To achieve the above-described object, the present invention provides the following solutions.

More specifically, the present invention provides a printing press having a printing cylinder rotatably supported by a movable member provided on the outside of a side frame, the diameter of the printing cylinder being changeable, the printing press comprising a first labyrinth plate provided on the circumference of a hole formed in the side frame, the first labyrinth plate extending in a direction substantially orthogonal to the axial direction of the printing cylinder and protruding toward a shaft portion of the printing cylinder, the shaft portion passing through the hole formed in the side frame; and a second labyrinth plate provided around the shaft portion, the second labyrinth plate being provided substantially parallel to the first labyrinth plate in the axial direction, with a gap formed between the first labyrinth plate and the second labyrinth plate, wherein an end position of the first labyrinth plate and an end position of the second labyrinth plate are set so that the first labyrinth plate and the second labyrinth plate overlap when the printing cylinder moves to any position in response to a change in the diameter.

In this way, the printing press comprises a first labyrinth plate provided on the circumference of a hole formed in the side frame, the first labyrinth plate extending in a direction substantially orthogonal to the axial direction of the printing cylinder and protruding toward a shaft portion of the printing cylinder, the shaft portion being passed through the hole formed in the side frame; and a second labyrinth plate provided around the shaft portion, the second labyrinth plate being provided substantially parallel to the first labyrinth plate in the axial direction with a gap formed between the first labyrinth plate and the second labyrinth plate, wherein an end position of the first labyrinth plate and an end position of the second labyrinth plate are set so that the first labyrinth plate and the second labyrinth plate overlap when the printing cylinder moves to any position in response to a change in the diameter. Therefore, oil and oil mist entering the inside of the printing unit from a space provided between the hole in the side frame and the shaft portion of the printing cylinder contact and are captured at the first labyrinth plate and the second labyrinth plate.

Therefore, since the oil and the oil mist do not enter the printing unit, the oil and the oil mist do not contaminate the inside of the printing unit, and defects, such as the need for cleaning, that adversely affect the printing quality can be prevented.

Here, the “printing cylinder” represents a plate cylinder and a blanket cylinder. However, in some cases, the “printing cylinder” may include an impression cylinder.

Here, the “shaft portion” of the printing cylinder represents a member present at a shaft section of the printing cylinder. More specifically, the “shaft portion” represents a member supporting a bearing, a bearing, or a shaft.

According to the present invention, the first labyrinth plate may be disposed outside the second labyrinth plate.

In this way, since the first labyrinth plate is disposed outside the second labyrinth plate, oil and oil mist that enter the printing unit from a space provided between the hole in the side frame and the shaft portion of the printing cylinder first contact the first labyrinth plate. Since the first labyrinth plate face the space, the capturing efficiency of oil and oil mist is improved.

According to the present invention, at least one of the first labyrinth plate and the second labyrinth plate may include a plurality of plates.

In this way, since at least one of the first labyrinth plate and the second labyrinth plate includes a plurality of plates, oil and oil mist that could not be captured at the first labyrinth plate and the second labyrinth plate can be captured at a subsequent first labyrinth plate or second labyrinth plate.

Therefore, oil and oil mist can be even more reliably captured.

According to the present invention, oil and oil mist can be sufficiently prevented from entering the printing unit.

### BRIEF DESCRIPTION OF DRAWINGS

FIG. 1 is a front view illustrating, in outline, the structure of a printing press according to an embodiment of the present invention.

FIG. 2 is a longitudinal cross-sectional view illustrating, in outline, the structure of a printing press according to an embodiment of the present invention.

FIG. 3 is a front view illustrating a moving unit of a printing cylinder according to an embodiment of the present invention.

FIG. 4 is a partial cross-sectional view illustrating a driven side of a blanket cylinder according to an embodiment of the present invention.

FIG. 5 is a front view, viewed from the inside of the printing unit, illustrating a sealing device according to an embodiment of the present invention.

### BEST MODE FOR CARRYING OUT THE INVENTION

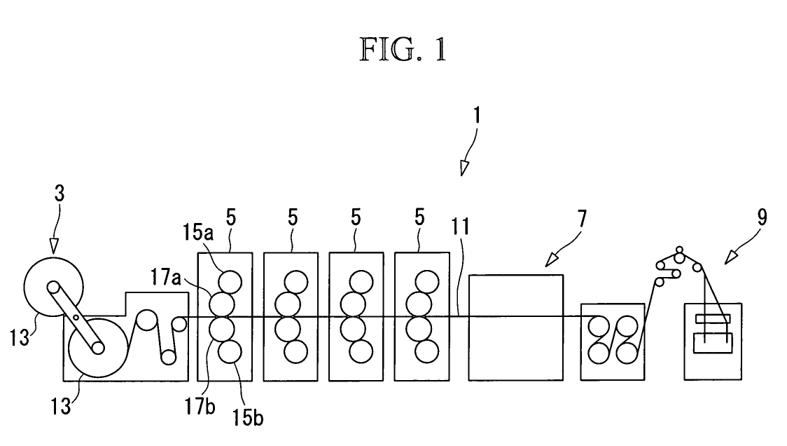

An embodiment of the present invention will be described below with reference to FIGS. 1 to 5.

In this embodiment, the present invention is applied to an opposing-blanket-type rotary press that is capable of printing multiple colors on both sides of a web.

FIG. 1 is a schematic front view illustrating the overall structure of a rotary press (printing press) 1.

The rotary press 1 includes a paper feeder 3 that supplies a web 11, printing units 5, a drying device 7 that dries a printed web, and a folding device 9 that cuts and folds the web 11 and outputs folded sheets.

The paper feeder 3 is configured to hold two paper rolls 13, which each consist of the web 11 wound into a roll. When paper is supplied from a first paper roll 13, a second paper roll 13 is loaded to prepare for paper splicing. When the remaining amount of the web 11 on the first paper roll 13 becomes small, it is spliced together with the web 11 of the second paper roll 13. Likewise, while the web 11 is supplied from the second paper roll 13, another paper roll 13 is loaded to prepare for paper splicing.

In this way, the web 11 is continuously sent out from the paper feeder 3 to the printing units 5.

The number of printing units 5 provided is the same as the number of colors to be printed. According to this embodiment, four printing units 5 are provided, used for printing cyan, yellow, magenta, and black, respectively. Color printing is carried out by mixing these colors.

The printing units 5 will be described below. Each of the printing units 5 includes plate cylinders 15a and 15b and blanket cylinders 17a and 17b. The blanket cylinder 17a and the blanket cylinder 17b are disposed facing each other with the web 11 interposed therebetween. The blanket cylinders 17a and 17b press against each other.

In the drawings, the suffixes ‘a’ and ‘b’ attached to reference numerals indicate the upper side and the lower side of the web 11, where ‘a’ indicates that a portion or a member is provided on the upper side, and ‘b’ indicates that the portion or member is provided on the lower side. Hereinafter, the suffixes ‘a’ and ‘b’ are used to indicate the upper side and the lower side. However, when this does not have to be indicated, the suffixes ‘a’ and ‘b’ will be omitted, and a portion or a member will be represented by a reference numeral alone.

The web 11 on which printing has been carried out on both sides by the printing units 5 is dried by the drying device 7 and is conveyed to the folding device 9.

At the folding device 9, the conveyed web 11 is cut in the longitudinal direction, folded in the longitudinal direction, folded in the lateral direction, and/or cut in the lateral direction, and is output as desired folded sheets.

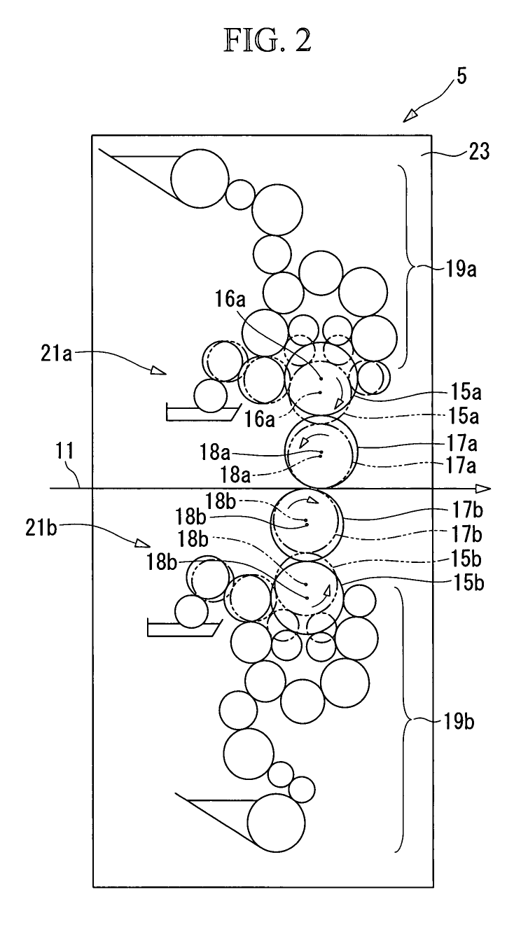

FIG. 2 is a longitudinal cross-sectional schematic view illustrating the overall structure of one of the printing units 5 included in the rotary press 1 according to this embodiment. The printing unit 5 includes the plate cylinders 15a and 15b to which plates for forming a printed image are attached, ink devices 19a and 19b that supply ink to image areas of the plates of the plate cylinders 15a and 15b, dampening devices 21a and 21b that supply dampening water to non-image areas of the plate cylinders 15a and 15b, and the blanket cylinders 17a and 17b that transfers the images formed on the plate cylinders 15a and 15b onto the web 11.

These members are supported by movable members provided on the outside of a pair of frames provided on both sides of the printing unit 5. One of the frames is referred to as a driven-side frame (side frame) 23, and the other frame is referred to as an manipulation-side frame (side frame) but is not shown in the drawing.

As indicated by the solid lines and double-dotted lines in FIG. 2, with the rotary press 1 according to this embodiment, the plate cylinders 15a and 15b and the blanket cylinders 17a and 17b can be changed to ones having different diameters (radii). In this way, for example, printing on A-series full-size landscape sheets and B-series half-size portrait sheets can be carried out.

When the diameters of the plate cylinders 15a and 15b and the blanket cylinders 17a and 17b are changed, the positions of axial centers 16a and 16b of the plate cylinders 15a and 15b and axial centers 18a and 18b of the blanket cylinders 17a and 17b move substantially vertically.

Furthermore, the positions of ink form rollers of the ink devices 19a and 19b and water form rollers of the dampening devices 21a and 21b are also changed.

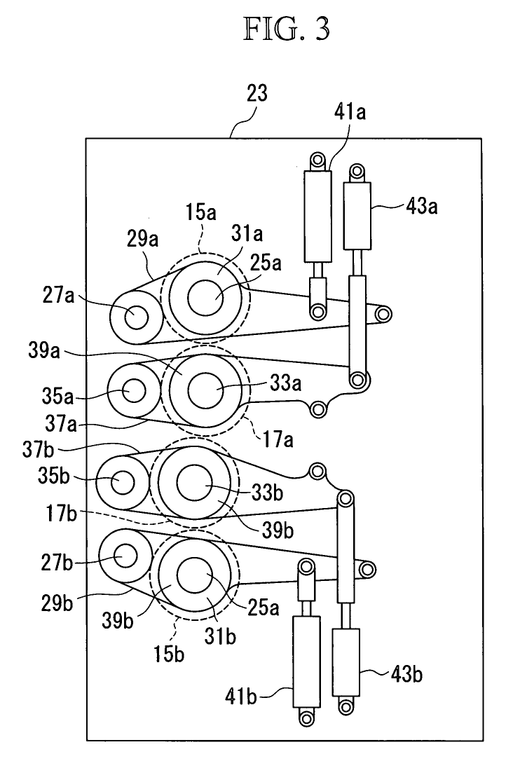

FIG. 3 is a front view illustrating the driven-side members that change the diameter of the printing cylinder in the printing unit 5.

A shaft (shaft portion) 25 of the plate cylinder 15 is held on the driven-side frame 23 with a bearing 31 at the middle area of a lever 29, which is attached so as to be capable of sliding around a supporting shaft 27.

A shaft (shaft portion) 33 of the blanket cylinder 17 is held on the driven-side frame 23 with a bearing 39 at the middle area of a lever 37, which is attached so as to be capable of sliding around a supporting shaft 35.

The free end of the lever 29 is attached to a rod of an actuator 41, which is attached so as to be capable of sliding to the driven-side frame 23, with a pin. The free end of the lever 37 is attached to a rod of an actuator 43, which is attached so as to be capable of sliding to the driven-side frame 23, with a pin.

The actuators 41 and 43 may be comprinting pressed-air actuators, hydraulic actuators, or an electric motor. The actuators 41 and 43 shown in the drawings are hydraulic cylinders.

According to such a structure, by operating the actuators 41 and 43, the lever 29 and 37 are rotated around the supporting shafts 27 and 35 so as to change the positions of the bearings 31 and 39, i.e., center positions 16 and 18 of the plate cylinder 15 and the blanket cylinder 17.

The same structure is also provided for the manipulation-side frame. By operating these in synchronization, the positions of the plate cylinders 15 and the blanket cylinders 17 can be efficiently changed.

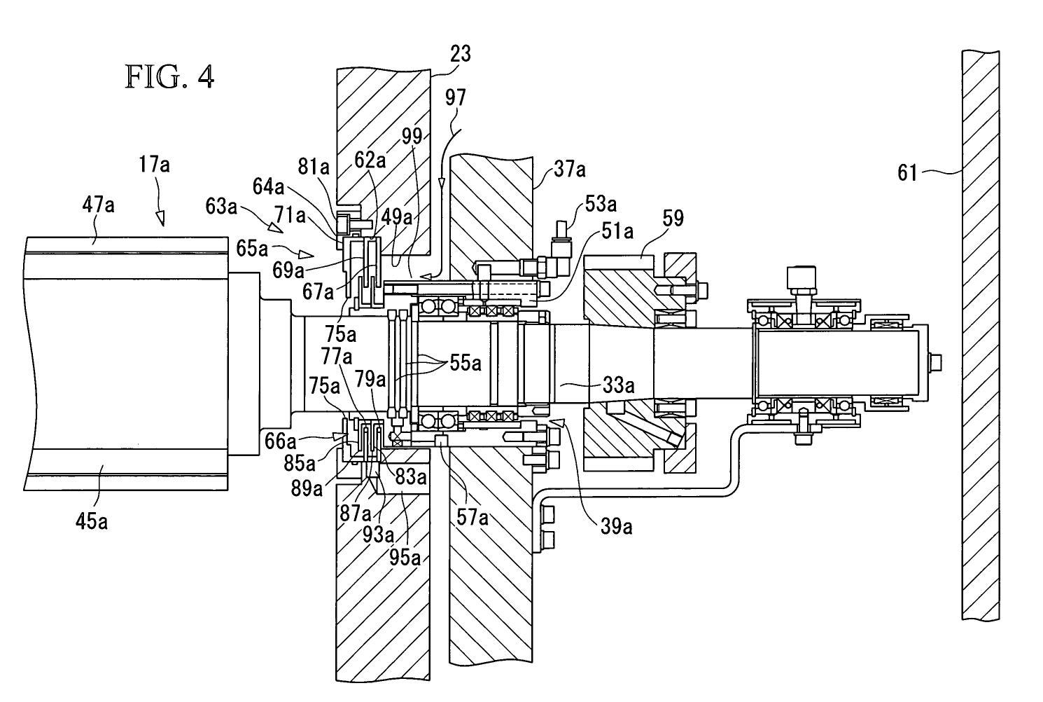

FIG. 4 is a cross-sectional view of the driven side of the blanket cylinder 17a.

The blanket cylinder 17 includes a blanket cylinder main body 45 and a sleeve 47 surrounding the blanket cylinder main body 45. By replacing the sleeve 47 with one having a different thickness, the diameter of the blanket cylinder 17 is changed.

In this way, the replacement operation can be easily carried out compared to replacing the entire blanket cylinder 17.

The shaft 33 of the blanket cylinder 17 extends outward through a hole 49 passing through the driven-side frame 23. The shaft 33 of the blanket cylinder 17 is rotatably supported by the bearing 39 attached to the lever 37.

The bearing 39 includes a bearing-supporting member 51 fixed to the lever 37, and ball bearings and roller bearings linearly aligned in the axial direction inside the bearing-supporting member 51.

Lubricating oil, supplied by a supplying pipe 53, is used for lubrication. Then, the oil is collected through three labyrinth grooves 55 provided toward an outlet, in the same manner as a known printing press, and is guided downward through a channel 57.

A driving gear 59 is attached to the outside of the lever 37 of the shaft 33 of the blanket cylinder 17. The driving gear 59 is engaged with an adjacent driving gear (not shown) so as to transmit a driving force.

These driving gears are lubricated by pouring a large amount of lubricating oil from above. Therefore, the driving gears are covered by a gear case 61 attached to the driven-side frame 23 to prevent the lubricating oil from spattering in the vicinity.

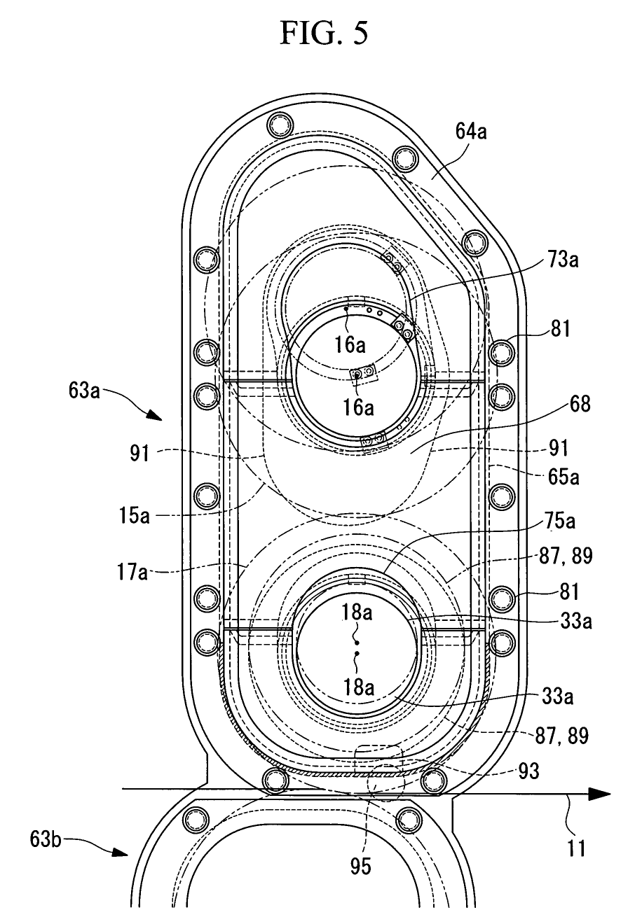

Next, a sealing device 63 will be described with reference to FIG. 5. FIG. 5 is a front view of the sealing device 63, provided on the driven side, viewed from the inside of the printing unit 5.

The sealing device 63 includes a frame-side labyrinth plate member 65 attached to the driven-side frame 23, a blanket-cylinder-side labyrinth plate member 66 attached to the bearing-supporting member 51 of the bearing 39, a plate-cylinder-side labyrinth plate member 68 attached to the shaft portion of the plate cylinder 15, and an attachment member 64 that attaches the frame-side labyrinth plate member 65 to the driven-side frame 23.

According to this embodiment, the sealing device 63 is formed as a single unit together with the plate cylinder 15 and the blanket cylinder 17, as shown in FIG. 5, and is engaged with and attached to a deprinting pression 62 formed in the inside of the driven-side frame. The sealing device 63 may be formed separately from the plate cylinder 15 and the blanket cylinder 17.

The frame-side labyrinth plate member 65 includes, from the outer side to the inner side, a first frame-side labyrinth plate (first labyrinth plate) 67, a second frame-side labyrinth plate (first labyrinth plate) 69, and a third frame-side labyrinth plate (first labyrinth plate) 71.

The first frame-side labyrinth plate 67, the second frame-side labyrinth plate 69, and the third frame-side labyrinth plate 71 extend in directions orthogonal to the axial direction of the shaft 33.

The second frame-side labyrinth plate 69 and the third frame-side labyrinth plate 71 have flanges that maintain distances between them and the first frame-side labyrinth plate 67 and the second frame-side labyrinth plate 69, respectively.

When viewed in the axial direction of the blanket cylinder 17, the frame-side labyrinth plate member 65 (third frame-side labyrinth plate 71) is shaped as a rice bag with a projecting upper left portion. A substantially oval shaped opening 73 is formed in the upper middle area in the horizontal direction (end position), and a substantially oval shaped opening 75 is formed in the lower middle area in the horizontal direction (end position).

The opening 73 is formed so as to surround the circumference of the shaft 25 of the plate cylinder 15 and is large enough to allow the shaft 25 to move.

Openings that are slightly larger than the opening 73 are formed in the first frame-side labyrinth plate 67 and the second frame-side labyrinth plate 69 at the same positions as that of the opening 73.

The opening 75 is formed so as to surround the circumference of the shaft 33 of the blanket cylinder 17 and is large enough to allow the shaft 33 to move.

Openings 77 and 79 that are slightly larger than the opening 75 are formed in the second frame-side labyrinth plate 69 and the first frame-side labyrinth plate 67 at the same positions as that of the opening 75.

The attachment member 64 is a ring-shaped member provided around the circumference of the frame-side labyrinth plate member 65. A thin-walled portion that overlaps with the peripheral portion of the frame-side labyrinth plate member 65 is provided inside the attachment member 64. The thin-walled portion is engaged with the frame-side labyrinth plate member 65 so as to attach the attachment member 64 to the driven-side frame with bolts 81, and the frame-side labyrinth plate member 65 is fixed to the driven-side frame 23.

The blanket-cylinder-side labyrinth plate member 66 has, from the outside to the inside, a first blanket-side labyrinth plate (second labyrinth plate) 83 and a second blanket-side labyrinth plate (second labyrinth plate) 85.

The first blanket-side labyrinth plate 83 and the second blanket-side labyrinth plate 85 are donut-shaped plates that extend in a direction orthogonal to the axial direction of the shaft 33.

Flanges are provided on the shaft-33-side ends of the first blanket-side labyrinth plate 83 and the second blanket-side labyrinth plate 85 so as to maintain distances between them and the adjacent first blanket-side labyrinth plate 83 and bearing-supporting member 51, respectively.

The first blanket-side labyrinth plate 83 is interposed, with space provided on both sides, between the first frame-side labyrinth plate 67 and the second frame-side labyrinth plate 69. The second blanket-side labyrinth plate 85 is interposed, with space provided on both sides, between the second frame-side labyrinth plate 69 and the third frame-side labyrinth plate 71.

The positions of an outer circumference edge (end position) 87 of the first blanket-side labyrinth plate 83 and an outer end (end position) 89 of the second blanket-side labyrinth plate 85 change as the blanket cylinder 17 moves. However, these overlap with the frame-side labyrinth plate member 65 at all positions.

The plate-cylinder-side labyrinth plate member 68 has substantially the same structure as the blanket-cylinder-side labyrinth plate member 66, except that an outer circumferential edge (end position) 91 has a substantially oval shape.

An oil chamber 93 is provided at the lower area of the sealing device 63. The oil chamber 93 communicates with the outside of the driven-side frame 23 via an oil channel 95 formed in the driven-side frame 23.

The operation of the above-described rotary press 1 according to this embodiment will be described below.

At the printing unit 5, images are color-printed on both sides of the web 11 let out from the paper feeder 3. At the printing unit 5, water is supplied from the dampening device 21 to the non-image areas of a plate attached to the circumferential surface of the plate cylinder 15, and then, ink is supplied from the ink device 19 to the image areas of the plate. The image formed on the plate in this way is transferred onto the blanket cylinder 17 and then transferred from the blanket cylinder 17 onto the web 11 running between the blanket cylinder 17a and the end sections 17b. In this way, single-color printing is carried out. This process is repeated four times to carry out color printing.

The ink on the web 11 on which printing has been carried out at the printing unit 5 is dried at the drying device 7. Then, the web 11 is sent to the folding device 9 where the web 11 is folded into predetermined folded sheets and output.

Next, an installation method of the sealing device 63 will be described.

The frame-side labyrinth plate member 65 is separated into three sections by being cut laterally at substantially the axial center position of the plate cylinder 15 and substantially the axial center position of the blanket cylinder 17.

Since the blanket-cylinder-side labyrinth plate member 66 and the plate-cylinder-side labyrinth plate member 68 are attached to the bearing-supporting member 51, the blanket-cylinder-side labyrinth plate member 66 and the plate-cylinder-side labyrinth plate member 68 can be positioned at predetermined positions by installing the plate cylinder 15 and the blanket cylinder 17.

In this state, the frame-side labyrinth plate member 63 divided into three sections is installed; the first frame-side labyrinth plate 67, the second frame-side labyrinth plate 69, and the third frame-side labyrinth plate 71, and the first blanket-side labyrinth plate 83 and the second blanket-side labyrinth plate 85 are positioned so as to be alternately disposed; and the frame-side labyrinth plate member 65 is fixed to the driven-side frame 23 with the attachment member 64.

Next, the operation of the sealing device 63 will be described, wherein the blanket cylinder 17 is described as a typical cylinder.

While printing with the printing unit 5, a large amount of oil flows downward from the upper area in the gear case 61 on the driven side so as to lubricate the driving gear 59 and so on. Since the oil is scattered by the rotation of the driving gear 59 and so on, oil and oil mist fills the inside of the gear case 61.

Oil and oil mist 97 moves between the driven-side frame 23 and the lever 37 and enters a gap 99 formed between the hole 49 in the driven-side frame 23 and the bearing 39.

The oil and the oil mist 97 that has entered the gap 99 contacts the first frame-side labyrinth plate 67 opposing the gap 99, and most of the oil and the oil mist 97 is captured.

In this way, since the oil and the oil mist 97 contacts the first frame-side labyrinth plate 67 opposing the inlet channel of the oil and the oil mist 97, substantially all of the oil and the oil mist 97 contacts the first frame-side labyrinth plate 67. Thus, the capturing effect at the first frame-side labyrinth plate 67 is great, and the capturing efficiency of the entire apparatus can be improved.

The remaining oil and the oil mist 97 contacts the first blanket-side labyrinth plate 83 and is captured. This is repeated at the second frame-side labyrinth plate 69, the second blanket-side labyrinth plate 85, the third frame-side labyrinth plate 71, in order, so as to catch substantially all of the oil and the oil mist 97.

In this way, the oil collected by the frame-side labyrinth plate member 65 and the blanket-cylinder-side labyrinth plate member 66 flows downward along the frame-side labyrinth plate member 65 and the blanket-cylinder-side labyrinth plate member 66, is collected in the oil chamber 93, and is discharged outside the driven-side frame 23 via the oil channel 95.

On the other hand, lubricating oil supplied from the supplying pipe 53 to the bearing 39 lubricates the bearing and is then collected by the three labyrinth grooves 55 formed toward the outlet, in the same way as a known apparatus, is guided downward through the channel 57, and is discharged outside the driven-side frame 23.

The discharged oil is collected at the lower area of the gear case and is reused.

In this way, according to this embodiment, since oil and oil mist inside the gear case 61 is captured at the sealing device 63, and the lubricating oil for the bearing 39 is collected at the labyrinth grooves 55, the oil and oil mist can be prevented from entering the inside of the printing unit. Accordingly, since the inside of the printing unit 5 is not contaminated with oil and oil mist, cleaning is not required. Moreover, an adverse effect on the printing quality caused by oil mist attaching to the plate and the web 11 can be prevented.

1. A printing press having a printing cylinder rotatably supported by a movable member provided on the outside of a side frame, the diameter of the printing cylinder being changeable, the printing press comprising:
a first labyrinth plate provided on the circumference of a hole formed in the side frame, the first labyrinth plate extending in a direction substantially orthogonal to the axial direction of the printing cylinder and protruding toward a shaft portion of the printing cylinder, the shaft portion passing through the hole formed in the side frame; and
a second labyrinth plate provided around the shaft portion, the second labyrinth plate being provided substantially parallel to the first labyrinth plate in the axial direction, with a gap formed between the first labyrinth plate and the second labyrinth plate,
wherein an end position of the first labyrinth plate and an end position of the second labyrinth plate are set so that the first labyrinth plate and the second labyrinth plate overlap when the printing cylinder moves to any position in response to a change in the diameter.

2. The printing press according to claim 1, wherein the first labyrinth plate is disposed outside the second labyrinth plate.

3. The printing press according to claim 1, wherein at least one of the first labyrinth plate and the second labyrinth plate comprises a plurality of plates.
